(19) United States
(12) Patent Application Publication
(10) Pub. No.: US 2002/0129490 A1
(43) Pub. Date: Sep. 19, 2002

(54) Device and method to complete reinforcement cages

(76) Inventors: Del Fabro Giorgio, Tricesimo (IT); Del Fabro Marcello, Tavagnacco (IT)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/100,092

(22) Filed: Mar. 19, 2002

(30) Foreign Application Priority Data
Mar. 19, 2001 (IT) UD2001A000055

(51) Int. Cl. B23P 19/00; E04H 12/00

(52) U.S. Cl. 29/700; 52/649.3

(57) ABSTRACT

Device (10) and method to complete reinforcement cages comprising a plurality of longitudinal rods (13) and stirrups (12) separated at intervals along the rods (13). The device (10) is used to position the longitudinal rods (13) in correspondence with the inner corners of the stirrups (12), and comprises supporting means defining a plane (23, 123) which supports a pre-cage (11) comprising the stirrups (12) and the longitudinal rods (13) arranged free within the perimeter of the stirrups (12). One corner of the stirrups (12) rests on, and faces towards the outside of, the plane (23, 123). Lifting elements (25) lift the pre-cage (11) to overturn it partly and in sequence on the plane (23, 123), so as to take on each occasion a different corner of the stirrups (12) into an adjacent position facing towards the outside of the plane (23, 123).

### FIELD OF THE INVENTION

The invention concerns a device and a method to complete reinforcement cages employed in reinforced concrete structures such as beams, pillars or foundations.

The invention is intended to facilitate the operations to position and attach a plurality of longitudinal rods, arranged free inside the perimeter of the stirrups, at least in correspondence with the corners of the stirrups.

The invention is applied to cage-forming machines intended to form reinforcement cages or pre-cages in a substantially automatic fashion.

### BACKGROUND OF THE INVENTION

In the state of the art, metal cages employed as reinforcement in reinforced concrete structures comprise a plurality of longitudinal rods to which stirrups separated at intervals lengthwise are associated.

These cages can be assembled in two successive steps, by first preparing a substantially standardized pre-cage, consisting of the stirrups held together in the positions set out in the design specifications by two or more auxiliary longitudinal profiles, and subsequently completing the cage with the longitudinal rods according to the design specifications to be attached inside or outside the perimeter of the stirrups.

Inserting and attaching the longitudinal rods according to design specifications inside the perimeter of the stirrups is a difficult operation, however, especially if the cages to be made, and hence the relative rods, are very long; these operations entail risks to the safety of the workers, a large work force, the need for equipment and risks of damaging the material.

It is known that a device, the object of a patent application in the name of the present Applicant, which allows the longitudinal rods to be automatically inserted inside the closed perimeter of the stirrups during the progressive formation of the pre-cage.

This device greatly facilitates the subsequent operations to complete the cage, since it avoids the complex operations of inserting the rods between the stirrups. With this device, however, the rods are not constrained to the stirrups, but are free to move inside the perimeter thereof; during the operations to discharge the pre-cage this can cause uncontrolled movements of the rods, a high level of noise, the danger of accidents for the operators and other disadvantages.

In any case, however, complex operations are required to position and attach the longitudinal rods to the stirrups, which must be carried out after having discharged the pre-cage to an appropriate seating.

The present Applicant has devised and embodied this invention to overcome these shortcomings, and to obtain other advantages.

### SUMMARY OF THE INVENTION

The invention is set forth and characterized in the main claims, while the dependent claims describe other characteristics of the invention.

The purpose of the invention is to achieve a device and a method suitable to facilitate the operations to position and attach longitudinal rods according to design specifications at least in the corner position inside the perimeter of the stirrups of a pre-cage.

The invention is applied to cage-forming machines wherein the longitudinal rods according to design specifications are located inside the closed perimeter of the stirrups during the formation of the pre-cage.

The invention provides that when the pre-cage is complete, it is discharged and arranged on a supporting plane.

In one embodiment of the invention, the supporting plane consists of an inclined plane which has stop means at the end.

The device according to the invention comprises lifting means, distributed and substantially aligned over the length of the supporting plane, which are able to be selectively activated to lift the pre-cage and rotate it on the plane where it is resting. In this way, with every lifting cycle and subsequent overturning thereof, the pre-cage is located with a specific different corner adjacent to said plane and arranged towards the outside thereof, in a position facing towards the operators.

Therefore, the operators can easily position and attach at least one rod according to design specifications each time, in correspondence with said specific corner of at least some of the stirrups of the pre-cage, said corner being always in a position where the operators can work easily.

By progressively repeating the cycle of rotation of the cage and subsequent attachment of the rods according to design specifications for all or at least some of the corners of the stirrups, the cage can be discharged from the machine with all the rods already positioned and attached at least in correspondence with the corners; this facilitates any possible further steps to complete the cage, and eliminates those disadvantages connected to the free and uncontrolled movements of the rods inside the perimeter of the stirrups during the subsequent movement of the pre-cage.

In the case of an inclined plane, with every cycle to lift and overturn the cage, the longitudinal rods arranged inside the perimeter of the stirrups are all taken by the force of gravity towards the zone, or corner, of said perimeter associated with said stop means. Every time the pre-cage is overturned, it slides automatically downwards and is positioned with a different corner in correspondence with the stop means, thus facilitating the attachment of at least one rod on said corner.

### BRIEF DESCRIPTION OF THE DRAWINGS

These and other characteristics of the invention will be apparent from the following description of a preferential form of embodiment, given as a non-restrictive example with reference to the attached drawings wherein:

FIG. 1 is a schematic front view of a device according to the invention associated with a cage-forming machine;

FIG. 2 shows an enlarged detail of a component of the device in FIG. 1;

FIG. 3 shows the component in FIG. 2 in a second position;

FIG. 4 is a view from above of the device in FIG. 1;

FIG. 5 is a view from above of a cage obtained with the invention;

FIGS. 6-13 show the steps in the method according to the invention;

FIGS. 14-17 show the steps in the method according to a variant of the invention.

### DETAILED DESCRIPTION OF PREFERENTIAL EMBODIMENT

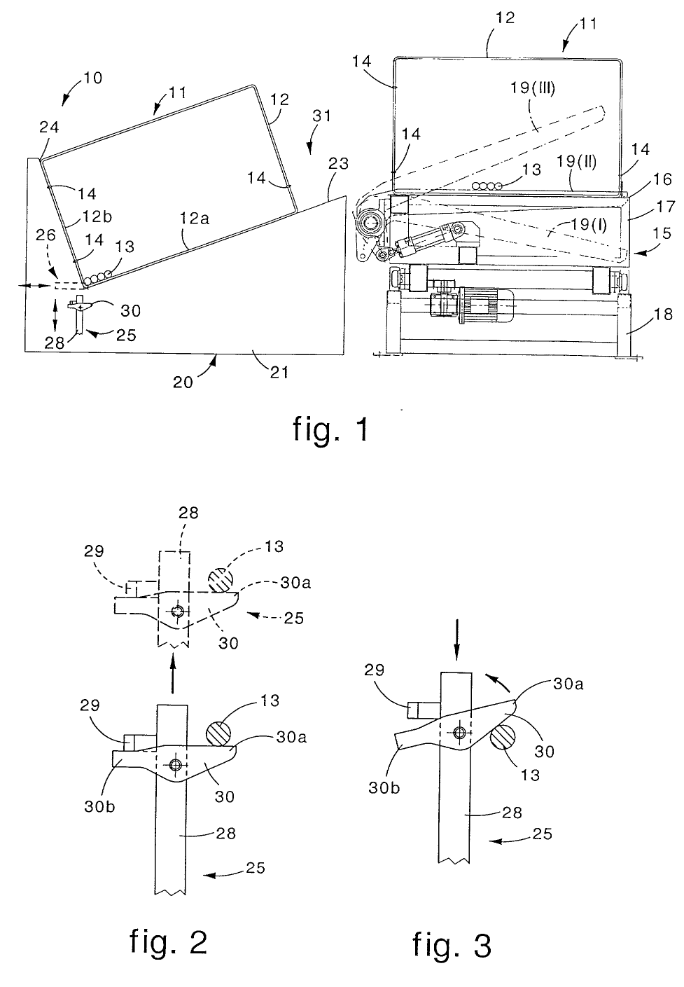

In the attached Figures, the number 10 denotes generally a device according to the invention able to position and attach longitudinal rods 13 according to design specifications at least in correspondence with the inner corners of stirrups 12 with a closed polygonal profile of a pre-cage 11, in order to obtain a complete cage 111. In this case, the stirrups 12 are arranged with an interaxis “i”, they are rectangular and comprise four inner corners α,β,γ,δwhere at least one longitudinal rod 13 is provided to be attached. The device 10 according to the invention is located next to a device 15 suitable to form a pre-cage 11, wherein said longitudinal rods 13 are inserted inside the perimeter of the stirrups 12 in the course of the formation of the pre-cage 11 (FIG. 1).

In this case, the pre-cage 11 consists of three auxiliary profiles 14 and a plurality of stirrups 12; the auxiliary profiles 14 are loop-shaped in correspondence with the stirrups 12 and are associated outside the latter.

The device 15 comprises a supporting plane 16 on which the pre-cage 11 is formed, assembled on a frame 17 attached to a base 18.

Along the frame 17 there are transverse arms 19 able to assume a first position “I” below the supporting plane 16, a second raised position “II” wherein they hold the longitudinal rods 13 raised to allow them to be inserted inside the perimeter of the stirrups 12, and a third discharge position “III” to discharge the pre-cage 11 with the rods inside.

The device 10 comprises a comb-type frame 20, mating in length with that of the pre-cage 11, and a plurality of lifting elements 25, and in this case welding elements 26 distributed along the frame 20.

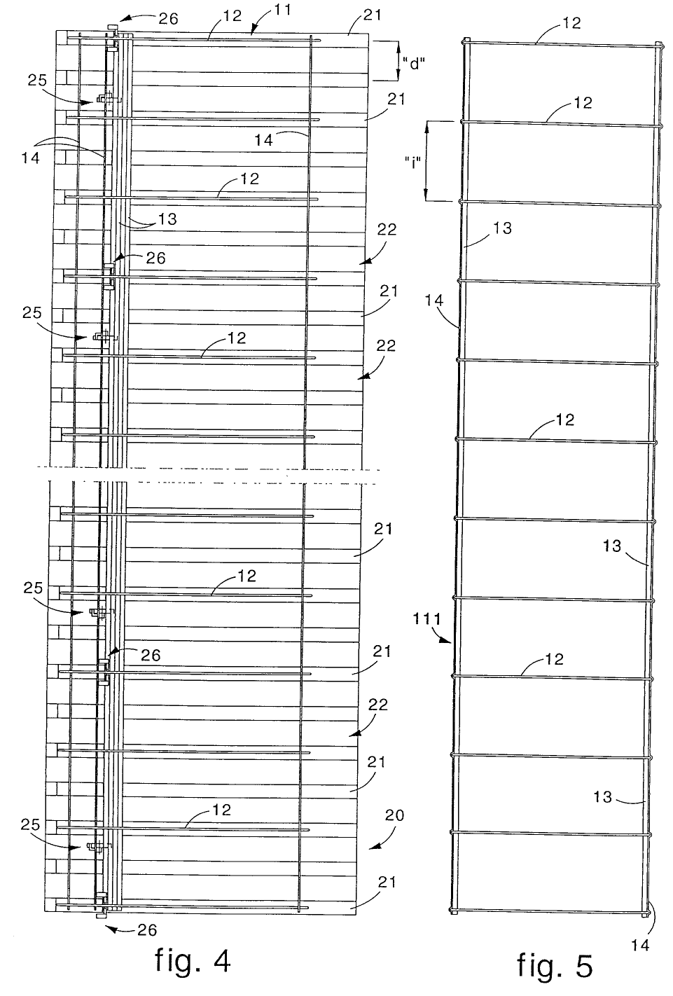

The comb-type frame 20 consists of a plurality of plates 21, arranged at a distance “d” from each other and separated by spaces 22 (FIG. 4). This distance “d” is advantageously a sub-multiple, in this case about half, of the interaxis “i”.

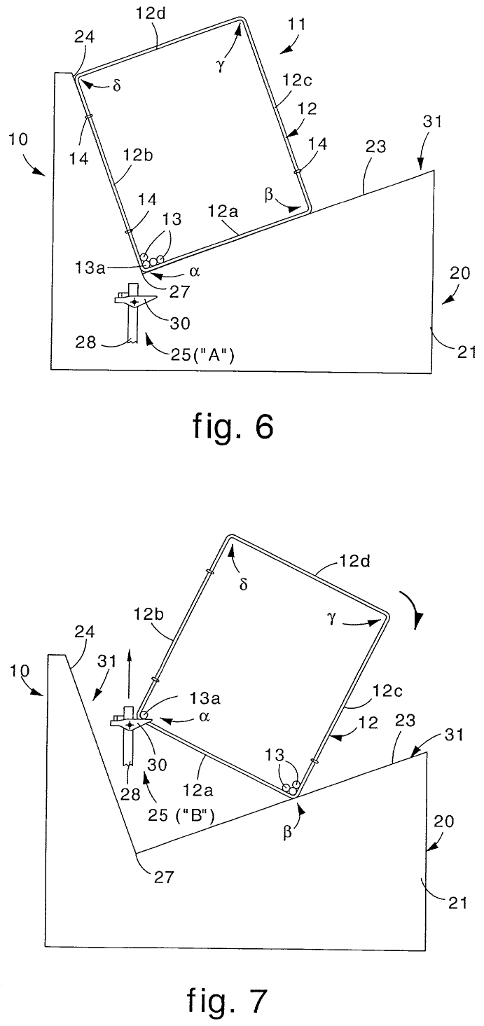

In the embodiment shown in FIGS. 6-13, the plates 21 in their entirety define a V-shaped seating 31, with the lower tip 27 on which the pre-cage 11 is rested. To be more exact, each plate 21 has an inclined plane 23 and a stop flank 24 defining the lower tip 27.

The inclined plane 23 receives the pre-cage 11, discharged by the means 19, and makes it slide downwards until one corner of the stirrups 12 stops against the stop flank 24. The lifting elements 25 are located in the spaces 22 between the plates 21 and are advantageously able to be positioned along the frame 20 according to the length of the cage 111.

Each lifting element 25 comprises a substantially vertical rod 28 on which an oscillating lever 30 is hinged, protruding from both sides with respect to the rod 28. The oscillating lever 30 is connected to the rod 28 by elastic means which keep it normally in a substantially horizontal operating position (FIG. 2) wherein it rests, with a rear part 30b, on top of an abutment element 29 solid with the rod 28.

The front part 30a of the oscillating lever 30 is arranged so as to interfere, when the rod 28 is raised, with the position of the lower tip 27.

The rod 28 is associated with actuator means, not shown here, able to move it vertically from a lowered position (“A”), wherein the lever 30 is below the lower tip 27, to a raised position (“B”) wherein the lever 30 moves at least above the lower tip 27.

The welding elements 26, arranged in a position mating with the lower tip 27 and in correspondence with at least some of the plates 21 (FIGS. 1 and 4) can be of any known type and therefore are not described in any detail here.

They are able to assume at least a working position wherein they are driven to attach a longitudinal rod 13 to the corner of the stirrups 12 located in correspondence with the lower tip 27. The welding elements 26 can also be located in different positions along the comb-type frame 20.

The method to complete a cage 111 starting from a pre-cage 11, using the device 10, is as follows.

The pre-cage 11, formed on the supporting plane 16 of the device 15 with the longitudinal rods 13 arranged inside the perimeter of the stirrups 12, is discharged laterally by raising the arms 19 into their third position “III” and is then overturned on the inclined plane 23.

The pre-cage 11 stops with one corner in correspondence with the stop flank 24, while the longitudinal rods 13 roll inside the stirrups 12 and collect towards the lower tip 27; in this step the lifting elements 25 are in the lowered position “A”.

The pre-cage 11 is therefore inclined with the first sides 12a of the stirrups 12 resting on the inclined planes 23 and the second sides 12b abutting on the stop flanks 24; the longitudinal rods 13 collect towards the corner αdefined between the first 12a and second 12b sides (FIG. 6).

With the pre-cage 11 in this position, the welding elements 26 are activated to attach at least a first longitudinal rod 13a to at least some of the stirrups 12 in correspondence with said corner α.

Then, the welding elements 25 are lifted and, as they are lifted, the relative oscillating levers 30 move into contact with the longitudinal rod 13a already attached to the stirrups 12, progressively lifting the entire pre-cage 11.

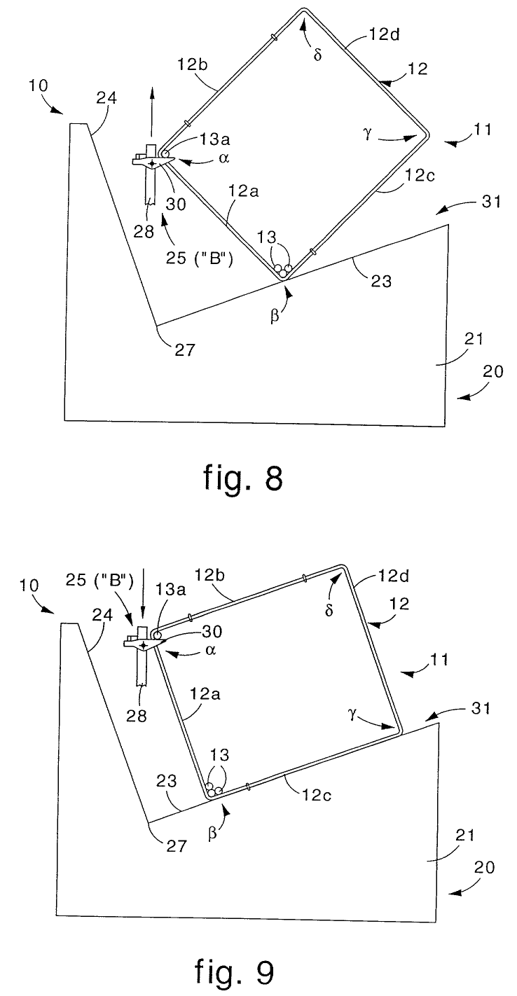

The lifting operation performed by said lifting elements 25 causes the pre-cage 11 to rotate (FIG. 7), while the free longitudinal rods 13 slide due to the force of gravity towards the corner βof the stirrups 12 defined between the first side 12a and a third side 12c opposite the second side 12b (FIG. 8).

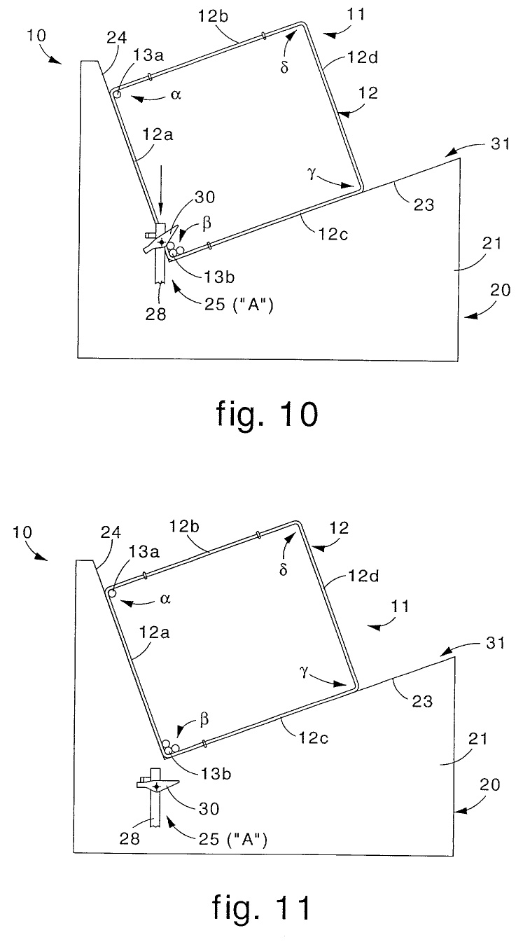

The lifting of the elements 25 continues until the pre-cage 11 is overturned by 90° and the third sides 12c of the stirrups 12 are resting on the inclined planes 23; then the lifting elements 25 are lowered again, so that the pre-cage 11 slides downwards on the inclined planes 23 (FIG. 9), and the corner β of the stirrups 12 is located in correspondence with the lower tip 27. As the lifting elements 25 descend, the oscillating levers 30 come into contact with the longitudinal rods 13 which are not attached, whose interference overcomes the resistance of the elastic means of the levers 30, making the levers 30 rotate to allow them to pass (FIG. 10) to the lowered position “A” (FIG. 11).

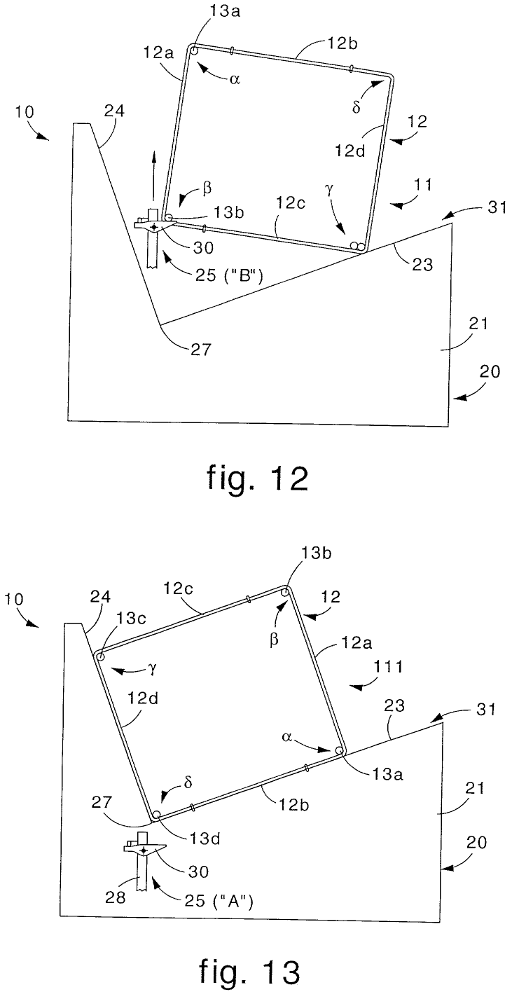

In the new position of the pre-cage 11, at least a second longitudinal rod 13b is arranged in correspondence with the corner β and in this position it can be attached to the stirrups 12 by the welding elements 26. Then, the lifting elements 25 are again activated, meeting the longitudinal rod 13b attached to the stirrups 12, and making the pre-cage 11 rotate again (FIG. 12) until it is overturned by another 90°, with the fourth sides 12d resting on the inclined planes 23.

The remaining rods 13 slide towards the corner γand a new rod 13c can be welded in correspondence with this corner.

The same procedure is then repeated to overturn the pre-cage 11 by another 90° , in order to take the last side 12b to rest on the inclined planes, with the corner δarranged in correspondence with the tip 27. In this position, a longitudinal rod 13d can easily be attached in correspondence with said corner. Once the fourth longitudinal rod 13d has been attached, the cage 111 is complete and can be discharged from the frame 20.

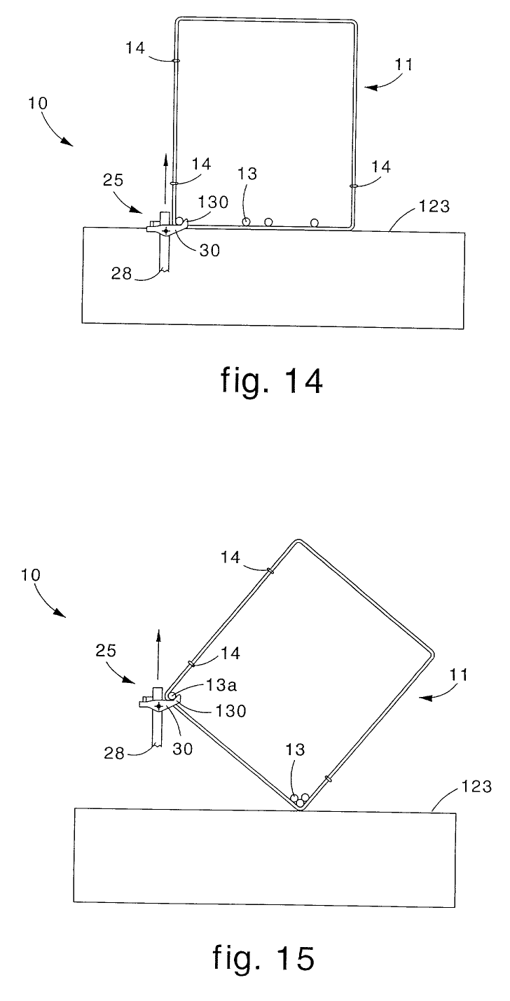

In the embodiment shown in FIGS. 14-17, the supporting plane 123 of the device 10 is substantially horizontal. In this case too, with every lifting cycle performed by the lifting elements 25 the pre-cage 11 is overturned, in this case by 90° in order to take a specific corner on each occasion to a position adjacent to the plane 123 and facing towards the outside thereof, so as to facilitate the operators in their operations to position and attach a longitudinal rod 13.

In this case, at least some of the levers 30 of the lifting elements 25 have one end 130 shaped like a hook, in order to prevent the pre-cage 11 from distancing itself from the outer end of the plane 123 during the lifting and overturning cycles.

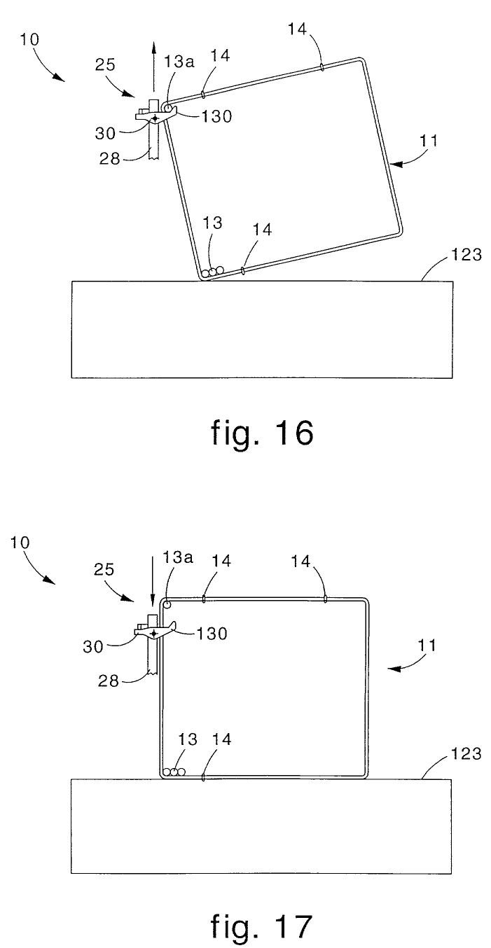

With this configuration, during the activation of the lifting elements 25, the lower tip of the pre-cage 11 is forced to slide on the supporting plane 23, 123 (FIGS. 15, 16); in this way, at the end of every cycle and after the elements 25 have returned in position, a new corner of the pre-cage 11 is always positioned substantially in the same position (FIG. 17) near the outer end of the plane 123, thus facilitating the operations to a position and attach a new rod 13 to be attached to said corner.

The device 10 can be associated with a command and control unit to automatically manage the activation of the lifting elements 25 and welding elements 26.

Modifications and/or additions can be made to the device 10 and method as described heretofore, without departing from the spirit and scope of the invention.

In the case of stirrups having a polygonal shape other than rectangular, the sequential cycle to overturn the cage will comprise a number of steps equal to the number of corners of said stirrups. Instead of the comb-type frame 20 there may be a single plane 23, 123, on which there are apertures for the passage of the lifting elements 25 and welding elements 26.

1. Device to complete reinforcement cages comprising a plurality of longitudinal rods (13) and stirrups (12) separated at intervals along said rods (13), said device being used to position said longitudinal rods (13), inserted inside the perimeter of said stirrups (12), in correspondence with the inner corners of said stirrups (12), characterized in that it comprises:
supporting means defining at least a plane (23, 123) able to support a pre-cage (11) comprising said stirrups (12) held together by auxiliary profiles (14) and said longitudinal rods (13) arranged free within the perimeter of said stirrups (12), one corner of said stirrups (12) being arranged substantially resting on, and facing towards the outside of, said plane (23, 123),
lifting elements (25) able to lift said pre-cage (11) to overturn it at least partly and in sequence on said plane (23, 123), so as to take on each occasion a different corner of said stirrups (12) into an adjacent position facing towards the outside of said plane (23, 123) and to facilitate the operations to attach at least one of said longitudinal rods (13) in correspondence with the inner corners of at least some of said stirrups (12).

2. Device as in claim 1, characterized in that said plane (23) is an inclined plane and cooperates at the end with stop means (24).

3. Device as in claim 1, characterized in that said plane (123) is substantially horizontal.

4. Device as in claim 1, characterized in that it comprises welding means (26) able to be selectively activated after every cycle of lifting and partial overturning of said pre-cage (11) in order to attach at least one of said longitudinal rods (13) in correspondence with a new corner of at least some of said stirrups (12).

5. Device as in claim 1, characterized in that said supporting means comprise a plurality of plates (21) defining between them a plurality of spaces (22) in which said lifting elements (25) and/or said welding elements (26) are able to be arranged.

6. Device as in claim 5, characterized in that said plates (21) are separated from each other by a distance (“d”) mating with the interaxis (“i”) between said stirrups (12).

7. Device as in any claim hereinbefore, characterized in that each of said lifting elements (25) comprises at least an oscillating lever (30) associated with elastic means able to keep it, as it is lifted, in a first operating position in which it is able to lift said pre-cage (11) and, as it is lowered, to allow it to be positioned in a retracted position when it meets interference means, to return below the position defined by said supporting plane (23, 123).

8. Device as in claim 7, characterized in that said oscillating lever (30) has an end (130) shaped like a hook able to prevent lateral displacements of said pre-cage (11) when it is lifted.

9. Device as in claim 7, characterized in that said lifting means (25) comprise actuator means able to move them vertically from a lowered position (“A”), wherein said oscillating lever (30) is located below said plane (23, 123), to a raised position (“B”), wherein said oscillating lever (30) is above said plane (23, 123), and vice versa.

10. Device as in claim 7, characterized in that said oscillating lever (30) cooperates with abutment means (29) able to prevent it from rotating during the lifting of said longitudinal rods (13).

11. Method to complete reinforcement cages comprising a plurality of longitudinal rods (13) and stirrups (12) separated at intervals lengthwise along said rods (13), used to position said longitudinal rods (13) in correspondence with the inner corners of the stirrups (12) of said cage (111), the method being characterized in that it provides the following steps:
a pre-cage (11) is prepared comprising said stirrups (12), held together in the design position by auxiliary profiles (14), and said longitudinal rods (13) are arranged free inside the perimeter of said stirrups (12);
said pre-cage (11) is positioned on a supporting plane (23, 123), and a first corner of said stirrups (12) is arranged in an adjacent position facing towards the outside of said plane (23, 123);
at least a first (13a) of said longitudinal rods (13) is attached in correspondence with said first corner of at least some of said stirrups (12);
said pre-cage (11) is lifted and partly overturned on said plane (23, 123) to locate a second corner of said stirrups (12) in said adjacent position facing towards the outside of the plane (23, 123);
a second longitudinal rod (13b) is attached in correspondence with said second corner;
the cycle of partial overturning of said pre-cage (11) is repeated for all the corners of said stirrups (12).

12. Method as in claim 11, characterized in that the rotation and partial overturning of said pre-cage (11) on said plane (23, 123) is actuated on each occasion by acting on a longitudinal rod (13) already attached to the stirrups (12).
